(19) United States
(12) Patent Application Publication
(10) Pub. No.: US 2014/0364094 A1
(43) Pub. Date: Dec. 11, 2014

(54) METHODS AND SYSTEMS FOR PROVIDING EFFICIENT TELECOMMUNICATIONS SERVICES

(71) Applicant: Starscriber Corporation, Vancouver (CA)

(72) Inventors: Dane Blackwell, Calgary (CA); Michael Johnson, Scottsdale, AZ (US); Ryan Jones, San Diego, CA (US)

(73) Assignee: Starscriber Corporation, Vancouver, B.C. (CA)

(21) Appl. No.: 14/123,880

(22) PCT Filed: Feb. 21, 2013
(86) PCT No.: PCT/US13/27093

§ 371 Date: Dec. 4, 2013

Related U.S. Application Data
(60) Provisional application No. 61/601,180, filed on Feb. 21, 2012.

(51) Int. Cl. H04M 1/725; H04W 4/12

(52) U.S. Cl. CPC H04M 1/72583; H04W 4/12
USPC 455/414.1

(57) ABSTRACT

Methods and systems for more efficiently providing telecommunications services are provided. A menu of options may be presented to a user upon detecting that the user has attempted to connect a call to a recipient. If the user selects an option before a predetermined amount of time has elapsed, the actions associated with that option may be performed instead of setting up a call between the user and the recipient. If the predetermined amount of time elapses without the user making a selection of an option or if the user has explicitly indicated a desire to establish the call, the call may be established

### CROSS-REFERENCE TO RELATED APPLICATIONS

This application claims priority to U.S. Provisional Patent Application No. 61/601,180, filed Feb. 21, 2012, the entire contents of which are hereby incorporated herein by reference.

### BACKGROUND

A fundamental value of a mobile network is its ability to deliver value to a user whenever and wherever the user may desire or need it. As such, the mobile network's value to a subscriber, and any event which creates value for the network, is time limited where “value” is inversely proportional to time from the perspective of both the subscriber and the network. Subscribers typically want to communicate as quickly as possible for the lowest cost. Mobile network operators typically want subscribers to spend money using the network and return for additional services.

The value of an event often must be realized within a window of time, referred to herein as an “event window”. An event window may be further defined as the time incurred by any request for service that results in value being created for the subscriber of a mobile network, the mobile network, or both. Direct dial calls, and the attempts to make such calls, over a mobile network are typically the most prevalent service request from a subscriber and occur frequently in an event window. Completed direct dial calls also deliver a significant portion of a mobile network operator's revenues. Such calls are a prime example of, but not the only, service requests that may occur in an event window from a network operator's perspective.

However, up to 50% or more of requests for direct dialed calls do not result in completed calls within the event window. Other than the small percentage of uncompleted call attempts that can be attributed to service problems such as, but not limited to, network connectivity or dialed party unavailability, the balance of uncompleted dialed calls reflect the inefficiency and ambiguity of current Service Request Resolution Practices (SRRP). Current SRRP fail in many cases to result in value for the subscriber or the network within the event window. Numerous methods have been deployed and utilized to deliver services that subscribers may desire or need as a result of a dialed call event that was not completed. For a significant portion of these uncompleted calls there is possibly that a subscriber had no intention of completing them (i.e., intentionally dropped call). In many cases the actual service desired by a subscriber can be triggered by the subscriber outside of (i.e., before or after) the dialed call event window. However, such services may not be capable of being triggered during the event window, which is precisely when the best opportunity to create value from such other services is most optimal due to the increased convenience and efficiencies that could be achieved for the subscriber and the network.

One example of less convenient and less efficient SRRP utilized by those skilled in the current art are Unstructured Supplementary Service Data (USSD) services that require a user to memorize and then type different character sequences than those used for a normal call. Some examples of USSD services and the character sequences that may be required to initiate such services are shown in FIG. 1. These character sequences may include non-numeric characters, such as the ‘*’ or ‘#’ characters on a normal mobile device keypad, and create what may be referred to as Symbolic Numeric Character Sequences (SNCS), where a string of symbols and numeric characters uniquely identify each type of SNCS that could trigger a service request. An example of this could be a call-me service. When using such a service, a SNCS of “*123#4564567890#” may be used, where “4564567890” would be the Party B number from which SNCS-sending Party A would like a call back (i.e., “4564567890” is the numeric character string (NCS) that Party A would otherwise call directly). The call-me service may then transmit a message to Party B that Party A would like to receive a call from Party B.

From a behavioral standpoint, SNCSs are less convenient to use than NCSs. For example, if a subscriber were to use five different services, the subscriber would have to memorize five unique SNCS. Since, in the call-me service example, a subscriber could, rather than using the call-me service with an SNCS, simply make an intentionally dropped call which deposited the subscriber's caller ID on the Party B mobile device and achieved the same results, without memorizing and/or entering any additional characters, or needing to remember the precise character sequence required, the subscriber is likely to not use the call-me service as it is less convenient than the simpler practice of merely calling the recipient and hanging up. There are numerous examples of such services, where a similar, but unique character string will launch any number of services that can only be triggered before or after a voice call event window, as the mobile device is in a dedicated “voice call session”, which must be terminated before a subscriber could enter a SNCS to trigger the USSD service. An important consideration is that during an NCS event, a subscriber is unable to use a USSD service because the NCS session would have to be terminated to allow the USSD SNCS to be entered by the subscriber, so a subscriber can essentially be in an NCS event or request a USSD service, but cannot do both within the event window.

### SUMMARY

Methods and systems for more efficiently providing telecommunications services are provided. A menu of options may be presented to a user upon detecting that the user has attempted to connect a call to a recipient. If the user selects an option before a predetermined amount of time has elapsed, the actions associated with that option may be performed instead of setting up a call between the user and the recipient. If the predetermined amount of time elapses without the user making a selection of an option or if the user has explicitly indicated a desire to establish the call, the call may be established.

In an embodiment, a messaging gateway may receive an first indication that an access attempt by a mobile device for any type of service was terminated within a first predetermined amount of time after initiation of the access attempt. The access attempt may have been terminated for any reason, including user termination, insufficient credit, network congestion, etc. Responsive to the indication, the messaging gateway may transmit an instruction to present a menu of options on the mobile device. The messaging gateway may then receive a second indication that a user has selected at least one of the options from the menu of options within a second predetermined amount of time after the menu has been presented and, in response, initiate at least one service associated with the at least one option without establishing the service requested by the access attempt. In other embodiments, the messaging gateway may initiate a service automatically or when no response has been received from a user device to menu options presented thereon. These and other aspects of the present disclosure are set forth in more detail below and in the figures.

### BRIEF DESCRIPTION OF THE DRAWINGS

FIG. 1 depicts exemplary USSD codes that may be entered by subscribers to acquire USSD services in the prior art.

FIG. 2 depicts an exemplary non-limiting system in which embodiments of the present disclosure may be implemented.

FIG. 3 depicts an exemplary non-limiting system method of implementing embodiments of the present disclosure.

FIG. 4 depicts exemplary non-limiting user interfaces according to an embodiment set forth herein.

FIG. 5 depicts exemplary non-limiting user interfaces according to an embodiment set forth herein.

FIG. 6 depicts exemplary non-limiting user interfaces according to an embodiment set forth herein.

FIG. 7 depicts exemplary non-limiting user interfaces according to an embodiment set forth herein.

FIG. 8 is a block diagram of a non-limiting exemplary mobile device in which embodiments of the present disclosure may be implemented.

FIG. 9 is a block diagram of a non-limiting exemplary processor in which embodiments of the present disclosure may be implemented.

FIG. 10 is a block diagram of a non-limiting exemplary packet-based mobile cellular network environment, such as a GPRS network, in which embodiments of the present disclosure may be implemented.

FIG. 11 illustrates a non-limiting exemplary architecture of a typical GPRS network, segmented into four groups, in which embodiments of the present disclosure may be implemented.

FIG. 12 illustrates a non-limiting alternate block diagram of an exemplary GSM/GPRS/IP multimedia network architecture in which embodiments of the present disclosure may be implemented.

FIG. 13 illustrates a PLMN block diagram view of an example architecture in which embodiments of the present disclosure may be implemented.

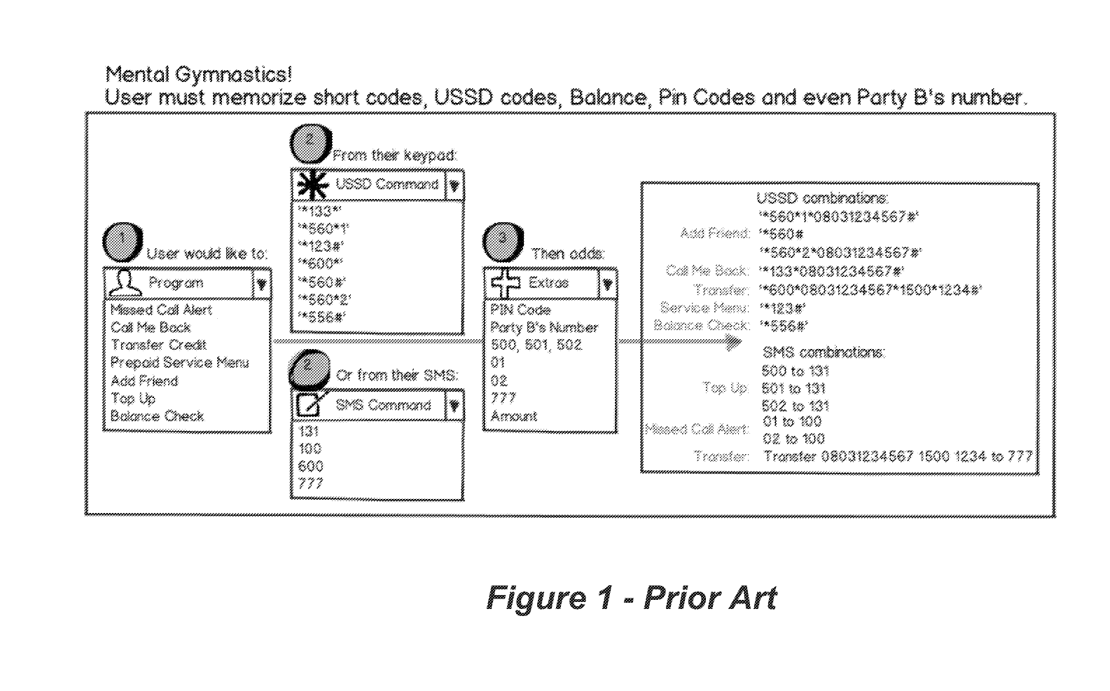

### DETAILED DESCRIPTION

In an embodiment, the inferred behavior of a subscriber can be determined coincident or during an NCS event window, increasing the certainty that a NCS is a voice call that can be processed by current SRRP, or allows the subscriber by acknowledgment to announce during the NCS event window a request for any number or type of other services. The invention creates a more convenient and efficient method for service selection and delivery than currently available methods, such as USSD services, that cannot currently be requested by a subscriber during a NCS event window and where, in an embodiment, one or more elements may format and deliver SNCS via alternative means through one or more network elements to trigger one or more USSD services. As shown in the figures, the present embodiments allow a subscriber to use more understandable means to acquire services than current means that include, for example, subscriber-provided USSD character sequences.

The ubiquitous adoption of mobile network services tapped into the deeply ingrained behavior of a society that utilized land line based voice calling services for decades. The only early difference was that a network element would actively capture individual numeric characters and then immediately launch a voice call upon completion of the numeric character string (NCS) with no further input from the dialing party. In mobile telephone environments, a more efficient method was needed, which was to allow the user to produce or provide a complete NCS which could be sent as a packet, resulting in the addition of the “Send” key to mobile devices for this purpose. For the purposes of this description, any reference to a “NCS” presumes that it is a properly formed phone number that may uniquely describe a Party B (e.g., dialed, recipient, or destination party), and/or has been received as such by one or more network elements with current SRRP capabilities. In a mobile network, for example, a dialed voice call may occur when a dialing mobile subscriber (Party A) produces a NCS and presses “Send” to deliver the NCS to one or more network elements. “Send” could be any number or type of inputs that cause the NCS to be sent to a network for validation, interpretation, and processing to initiate a voice call to the dialed party (Party B). In one embodiment, numeric keys may be used to form part of a mobile device's physical embodiment. Another embodiment may use a touch screen that displays numeric characters that can affect the same result, or any number of methods that present a complete numeric character sting that could result in the completion of a voice call, or imported from a memory location of some type that can be triggered more conveniently by Party A, such as a speed dial input, a redial input, or selected from a contact list or other such examples that may result in NCS delivery to one or more network elements with current SRRP capabilities.

All such methods of the delivery of a NCS may result in a voice call between Party A and Party B, and due to the uniqueness of the NCS for these purposes, an appropriate service response from one or more network elements that process the NCS. Such methods also presuppose that the only network service required by Party A is the completion of a voice call to Party B. The simplicity and convenience of this method for Party A, the presupposed unambiguity of the service request by Party A, and the ability to process the service request efficiently and accurately as a dialed voice call to Party B, within the original dialing event window, collectively define the most common and ubiquitously followed SRRP that historically has been determined to result in good value for mobile subscribers and mobile networks.

However, current SRRP operates under the assumption that the user's intent or desire is consistent with the interpretation of the user behavior presupposed by the receipt of a NCS by one or more network elements and that other physical conditions required for voice call completion are true or have been met. Those skilled in the practice of current voice SRRP know that a number of other physical conditions must be met for a voice call to result between Party A and Party B during the event window. The conditions may include, but are not limited to, that Party A has sufficient credit to pay for the call, that Party B is available or otherwise accepts and completes the connection from their end, that the connection to Party A is not terminated prior to connection to Party B, and any number of other conditions are true or have been met within the original event window defined by the receipt of a NCS packet by one or more network elements.

Since the receipt of an NCS and the current SRRP must consider all possible conditions that may affect the completion of the voice call, numerous other sub-processes or associated processes may be triggered or activated as a result of one or more of the possible conditions not being met during the event window, frustrating or possibly eliminating the possibility of service resolution as presupposed by the original interpretation of subscriber behavior within the event window. However, at no time during the event window have any of these current SRRP, which may or may not be triggered or activated during the event window, determined in a succinct or otherwise unambiguous way whether the original interpretation of the mobile subscriber's behavior, in this case the receipt of the original NCS by one or more network elements, is in fact an accurate interpretation of the intent behind the original subscriber behavior.

A number of examples can be cited which offer definitive evidence that current SRRP, which must count on an accurate interpretation of user behavior to effect voice and other services conveniently and efficiently, are increasingly challenged to interpret subscriber behavior accurately. Since the advent of mobile networks, those skilled in the art of operating and managing mobile networks have implemented many services and strategies to improve the probability that their SRRP will result in a completed voice call, based on the original interpretation of subscriber behavior inferred by the receipt of an NCS based voice event. In “Calling Party Pays” markets, one example is efforts to eliminate or reduce the probability that the lack of credit of Party A (calling party) could frustrate the completion of a voice call from Party A to Party B by service denial or other measures to educate or inform Party A of when a lack of credit may keep them from completing a voice call to Party B. Examples include, but are not limited to, providing a current credit balance to a mobile subscriber before and after a voice call, the use of an interactive voice response (IVR) service to announce that the call cannot be completed due to insufficient credit prior to service denial, and more convenient ways to purchase credits, with a goal to have a subscriber remedy this condition before making another call attempt that may result in service denial. In many cases however, where a user has no ability to buy more credits or has no financial capacity to purchase credits, such preventative strategies may be rendered moot.

In markets where significant numbers of users are new mobile participants, a higher percentage of these users and other mobile subscribers may gain a better understanding through these practices that they must have credits to avoid service denial through the employment of these practices. However, an unintended consequence of service denial for lack of credit may be that subscribers modify their behavior to avoid service denial, resulting in lower voice call completion rates, as opposed to the improvements in voice call completion that these services and strategies were expected to produce. One behavior modification made by subscribers is to make intentionally dropped calls, which consume no credits, before they entirely run out of credits. The rationale for this behavior may be to announce a subscriber's desire to receive a call from Party B, to announce that a subscriber has insufficient financial capacity to call Party B, to announce a subscriber's presence to Party B, or any of many other interpretations, including prearranged messaging, that may be known only to Party A and Party B. Processing a NCS without understanding whether the inferred subscriber behavior (e.g., that Party A intends to make a voice call) that the receipt of the original NCS presupposes is accurate triggers a SRRP process that likely will consume more network resources than service denial would have if Party A had entirely run out of credit. This situation will likely make these events more costly to the network. Preserving credits satisfies a subscriber's need or desire to sustain their ability to avoid service denial, and their desire to enjoy the full benefit of mobile service within their respective financial capacities, including the desirable benefits of being able to receive incoming calls that are always free.

The subscriber behavior of intentionally dropped calls may make up as much as 50%, and possibly more, of all NCS that current SRRP processes handle on many networks and may likely yield an uncompleted call due to Party A terminating the call prior to completion, even though all other service conditions required for call completion are true or have been met during the event window. Another way of describing this situation is that the subscriber, who initiated the event window, terminated the event window because the objective behind the service that the subscriber desired, but that was not interpreted or understood via the original behavior of presenting an NCS to the network, was fulfilled prior to the completion of the voice call.

Another example of inappropriate or suboptimal SRRP may be found in the SRRP response to other conditions that may not be true or met while processing a NCS with current SRRP. In the event that a voice call attempt presupposed by an original NCS fails due solely to the unavailability of Party B or Party B's inability or unwillingness to complete the voice call during the event window resulting in the same net condition, a typical SRRP is to close the event window and trigger an IVR service that offers to deliver a Voice Mail (VM) to Party B from Party A. This presupposes that the original attempt was to connect a voice call to Party B and that, with its unsuccessful outcome, Party A now expects to leave a VM, is willing to leave a VM, and/or sees any value in leaving a VM. It also presupposes that Party B will dial into the VM service to listen to the VM, without which the service session's value is rendered moot. The triggered response to the failure of the SRRP is also a flawed response as it presupposes that a new behavioral response can be inferred from the original behavioral response and that service delivery of some type can and should provide a result that can be of value to Party A and/or Party B. The probability that one or more of these suppositions is wrong or otherwise not desirable by one or both of Party A and Party B, which would likely be as a result of misinterpreting either the original subscriber behavior and/or the subsequent receiving party's behavior, is becoming increasingly high in many networks and is resulting in significant unrecovered network costs.

It is clear from these examples, and others not set forth herein, that gaining a better understanding of a subscriber's behavior coincident or as a result of the receipt of a NCS may result in a more appropriate SRRP. It is also clear that current SRRP, as practiced by those skilled the art, may likely result in the consumption of network resources that do not result in the completion of a voice call or provision or other services. It is also clear by these examples that basing subsequent SRRP, where one or more conditions are not true or are not met during the original event window, on the original behavior assumption may have a lower chance statistically of being the accurate or appropriate response to the originating NCS event.

In an embodiment, a method and system that overcomes the deficiencies of the current art may be used. Coincident to or during a NCS event window, a subscriber who initiates a NCS (Party A) may be presented with a message on the screen of their mobile device. One example of this message could be that it presents a countdown, such as “3”, “2”, “1”, or “10”, counting down to “1”, or other time frames suitable for the purposes of the embodiment, in combination with one or more service options they could trigger by message acknowledgement, hereinafter referred to as the “message”. If the subscriber, through physical input from the mobile device such as pressing a key, for example, acknowledges the message, this may likely indicate that the NCS is probably not a voice call as is normally expected by inferred subscriber behavior, but rather a request for one or more other services. Message acknowledgement may likely also terminate the voice SRRP to preserve network resources, such as, but not limited to, allocated voice channels, network switch capacity, and other such network resources. If the subscriber chooses to ignore the message, then the normal voice SRRP sequence may continue, and the message screen may simply disappear once it reaches its desired effective time limit, leaving the mobile screen in the state it was in prior to the NCS event window message presentation. This embodiment of the invention offers the most convenient way for a subscriber to confirm that their original inferred behavior via receipt of a NCS by one or more network elements is correct, by simply ignoring the message or essentially having to do nothing. In an embodiment, the network may allow the subscriber may be able to indicate their desire to complete the call by a designated signaling means which will return the call to the normal call process before the effective time limit expires.

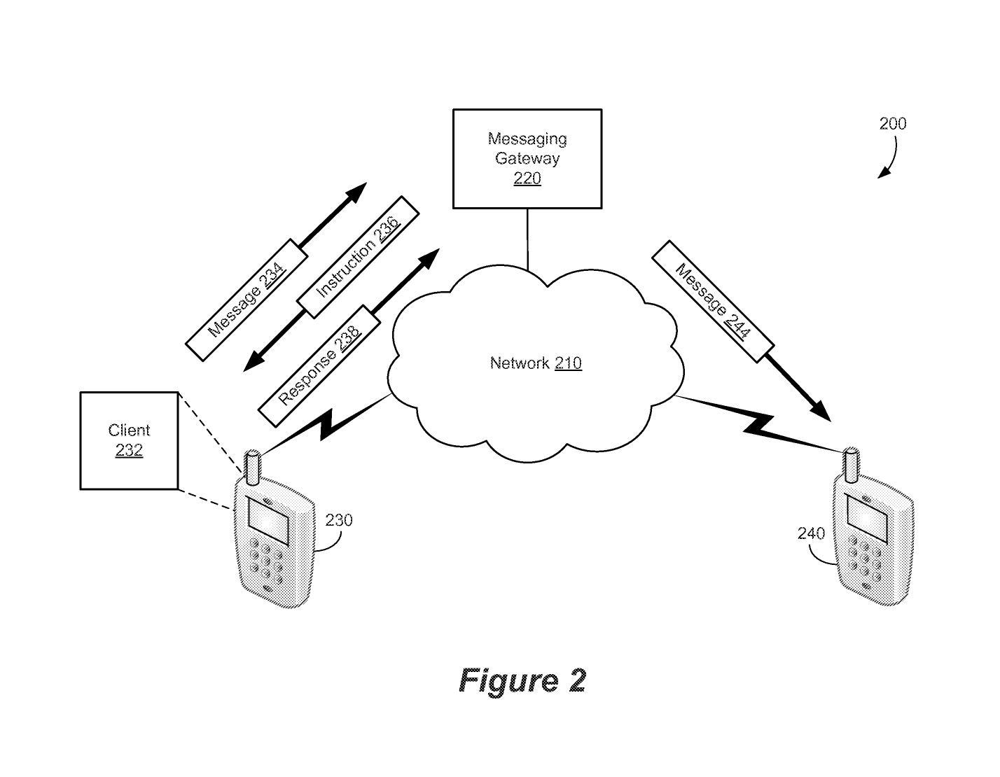

FIG. 2 illustrates system 200 in which embodiments of the present disclosure may be implemented. Network 210 may be any type of communications network that allows two devices, such as mobile devices 230 and 240, to communicate with one another using any communications means. Network 210 may be any type and any number of communications networks, including one or more wireless networks, one or more wired networks, and any combination thereof, implementing any number and type of communications protocols and technologies. Mobile devices 230 and 240 may each be any type of wireless communications device, including user equipment (UE), a wireless transmit and receive unit (WTRU), a mobile telephone, a wireless communications device, a smartphone, and any other communications device as disclosed herein, or any other type of device capable of being configured to perform the functions and features of the present disclosure. One or both of mobile devices 230 and 240 may instead be a wired communications device. Mobile devices 230 and 240 may be configured to communicate with network 210.

Configured on mobile device 230 may be client 232 that may be a software application that may execute on mobile device 230. Client 232 may be configured to facilitate communications with messaging gateway 220. In an embodiment, client 232 may detect one or more predetermined key sequences and/or NCSs and take responsive actions, such as transmitting the detected NCS or key sequence to another device, such as messaging gateway 220, or generating a message for transmission to another device in response to detecting the predetermined key sequences and/or NCSs. Alternatively, mobile device 230 may be configured such that all predetermined key sequences, NCSs, or any other type of communications may be transmitted to messaging gateway 220. In an embodiment, a device within network 210, such as a base station, home location register (HLR), mobile switching center (MSC), or any other device within network 210 may be configured to transmit or otherwise convey communications from mobile device 230 to messaging gateway 220 rather than processing such communications according to prior art SRRP. Client 232 may also, or instead, provide user interfaces such as those described herein. All such embodiments are contemplated as within the scope of the present disclosure.

Messaging gateway 220 may be any computing device of any type, or any number and combination of any devices of any type. Messaging gateway 220 may be configured to communication with network 210 and with other devices, such as mobile devices 230 and 240, via network 210. Messaging gateway 220 may be configured with hardware, software, and a combination thereof, that perform any of the functions and aspects set forth herein.

As a result of a user of mobile device 230 entering a key sequence or a NCS and hitting the “send” button on mobile device 230, message 234 may be transmitted to messaging gateway 220 via network 210. Message 234 may be simply a call request that is rerouted within network 210 to messaging gateway 220. Such rerouting may be performed by any device, including by a MSC and MSC server (MSS) configured to reroute all such messages, or a subset of such messages, for example, those from particular devices or users or intended for particular devices or user. In response to receiving message 234, messaging gateway may transmit instruction 236 to mobile device 230 that instructs mobile device 230 to present a menu or message to the user. Instruction 236 may be transmitted to mobile device 230 within a predetermined amount of time. Such a menu or message may be generated and/or caused to be presented on mobile device 230 by client 232, or mobile device 230 may alternatively be configured to present a menu. Examples of such menus and messages are set forth in other figures and associated descriptions herein. Messaging gateway 220 may determine the particular instruction, and any related data, such as a particular menu or message to present on mobile device 230, based on message 234 and/or data collected or otherwise obtained by messaging gateway 220. For example, messaging gateway 220, or a device to which messaging gateway 220 has access, may have historical data that indicating behaviors associated with mobile device 230 (or a user of mobile device 230) and particular call requests, sent messages, and any other requested service.

For example, messaging gateway 220 may have historical data that indicates that 90% of calls placed from mobile device 230 to mobile device 240 are dropped before a voice channel is successfully connected between these devices (i.e., call from mobile device 230 answered by a user of mobile device 240). In response, messaging gateway 220 may send, in instruction 236, an instruction requesting confirmation that the user of mobile device 230 desires to send a call-me message to the user of mobile device 240. Such confirmation may be indicated by the user of mobile device 230, in one embodiment via interaction with client 232 and in other embodiments using other means to interact with mobile device 230, and in response, mobile device 230 may transmit such a confirmation as response 238 to messaging gateway 220. Messaging gateway 220 may, in response, transmit a call-me message as message 244 to mobile device 240 requesting that the user of mobile device 240 call mobile device 230.

In an embodiment, messaging gateway 220 may use a reason that message 234 was generated in order to determine whether to send instruction 236 and if so, the content of the instruction. For example, message 234 may be generated by a device within network 210 that received a request from mobile device 230 to place a call and determined that an account associated with mobile device 230 does not have enough credit to place the call. In such an embodiment, message 234 may indicate (using a code, text, machine-readable language, etc.) that lack of credit. In response messaging gateway 220 may send instruction 236 to present a menu of options that allow a user of mobile device 230 to add credit to the account. The instruction may also cause mobile device 230 to present a notification that the account balance is insufficient to provide the requested service and that the requested access has been aborted.

In an embodiment, messaging gateway 220 may proceed with an action if no response is received from mobile device 230. For example, a menu or message presented on mobile device 230 in response to instruction 236 may indicate that if no response is received within a set amount of time, a particular action (e.g., transmit call-me message to mobile device 240) will be taken by messaging gateway 220. Upon expiration of a predetermined amount of time, messaging gateway 220 may automatically take the determined action.

Alternatively, a denial and/or request for alternate service may be detected on mobile device 230 and result in the transmission of response 238 with an indication of the denial and/or other requested service. Messaging gateway 220 may, in response, transmit an alternate message as message 244 to mobile device 240, establish a voice channel between mobile device 230 and mobile device 240, transfer money into or between accounts, locate mobile device 240, and/or take any other actions, some of which are described in further detail herein.

In another alternative, messaging gateway 220 may send, in instruction 236, an instruction causing mobile device 230 to present a message on mobile device 230 informing the user that a call-me message has been sent to mobile device 240. In such an embodiment, messaging gateway may automatically transmit message 244 to mobile device 240 requesting that the user of mobile device 240 call mobile device 230. Alternatively, messaging gateway 220 may send, in instruction 236, an instruction causing mobile device 230 to present a message on mobile device 230 informing the user messaging gateway 220 has determined an appropriate action based on message 234 and/or other criteria. In such an embodiment, messaging gateway may automatically perform the determined action. In other embodiments, messaging gateway 220 may automatically perform one or more determined actions, but may not send any indication of such actions to mobile device 230. Note that any type of analysis may be performed to determine an appropriate action, and any acknowledgement, denial of service for such action, and any other communication sent to a mobile device originating a message to a messaging gateway are contemplated as within the scope of the present disclosure.

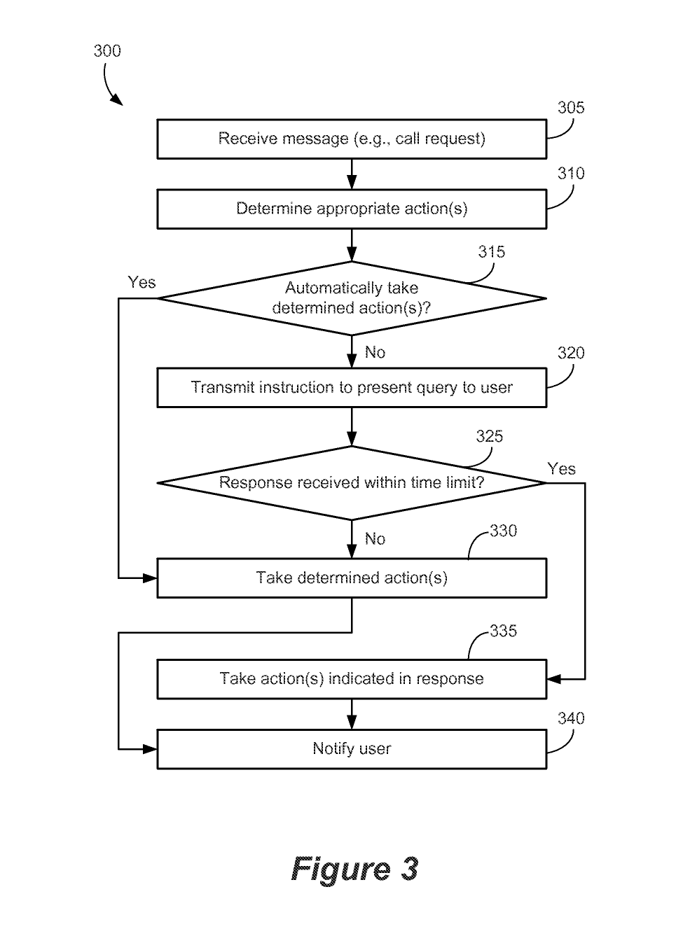

FIG. 3 illustrates non-limiting, exemplary method 300 of implementing an embodiment of the present disclosure. Method 300, and the individual actions and functions described in regard to method 300, may be performed by any one or more devices, including those described herein, such as any of the devices illustrated in FIG. 2. In an embodiment, method 300 may be performed by a system such as messaging gateway 220, by a mobile device such as mobile device 230, by a combination of such devices, or by any other network component, wireless mobile device, or by any other device or component or combination thereof, in some embodiments in conjunction with other network elements, wireless mobile devices, and/or software configured and/or executing on any network or network attached element or wireless mobile device. Note that any of the functions and/or actions described in regard to any of the blocks of method 300 may be performed in any order, in isolation, with a subset of other functions and/or actions described in regard to any of the other blocks of method 300 or any other method described herein, and in combination with other functions and/or actions, including those described herein and those not set forth herein. All such embodiments are contemplated as within the scope of the present disclosure.

At block 305, one or more messages may be received, for example at a device such as messaging gateway 220. The message(s) may be received from a mobile device, or from another network element. The message(s) may be a call request or a sequence of messages indicating more than one user actions, such as a call request followed shortly by a call termination (i.e., an intentionally dropped call.) Alternatively, the message received may be a message that represents one or more user actions and that was generated by another device or another system within a network, or by the same device receiving the message at block 305. For example, the received message may be a request for a supplementary service such as that described in U.S. patent application Ser. No. 12/303,339, filed Feb. 10, 2009, and entitled “Voiding Calls to Signal Supplementary Services”, the entire contents of which are hereby incorporated herein by reference. In such embodiments, a device within a network may detect a call request and call termination received within a predetermined period of time and interpret such a detection as a request to generate a call-me message. In response, this network device may generate a message indicating the detected sequence of call request and termination, and transmit that message to be received at block 305. Alternatively, any access attempt that is aborted or terminated after initiation by a user, such as a text message transmission, data session, voicemail composition, etc. may be detected and generate a message indicating the detected access attempt. The termination of the access attempt may be performed by the user or by the network or a network device. In some embodiments, such access attempts must be aborted or terminated within a predetermined amount of time (e.g., by the user or by the network) in order to trigger a message indicating the detected access attempt. All such embodiments are contemplated as within the scope of the present disclosure.

Alternatively, such a network device may interpret that sequence of call request and termination as an intended call-me request, and transmit a message requesting transmission of a call-me request that is received at block 305. In other embodiments, the message received at block 305 may be generated in response to a user action, but indicating a denial of service or some other network condition. For example, the message received at 305 may indicate that a user was rejected when attempting to make a call or send a message for lack of credit, network congestion, device incompatibility, or any other reason. In such embodiments, it may be desirable to offer to a user an alternate means of obtaining service and/or a means of obtaining additional credit, and so a menu of options and/or the option to send a call-me request may be presented to such a user.

Note that the event that triggered the message received at block 305 may be any type of event that may occur on any type of network and may involve any type of service (e.g., circuit switched network, PSTN, packet switched voice and/or data (e.g. SIP), text messaging, SMS, P2P session, etc.) and any such event may be the result of user actions, network actions, or a combination thereof. Note also that the message received at block 305 may include an originating telephone number, device identifier, and/or user identifier, and a destination telephone number, device identifier, and/or user identifier. The message may also include any other data. In some embodiments, the message received may indicate that the originating device and recipient device are the same, for example, a user sending a text message to himself or placing a call to himself. In such embodiments, an identifier in the message received at block 305 for an originating device may be the same as an identifier in the message for a recipient device. Note also that the destination/recipient/Party B number or identifier, as well as the originating counterparts, may be an alias or assigned to a different actual destination party, and may have any number of digits, characters, etc.

At block 310, one or more appropriate actions may be determined based on the message and, in an embodiment, based on other data. For example, where the message indicates a request to place a call from Party A to Party B and a subsequent call termination received before the call is completed (i.e., call from party A answered by Party B), a query of historical data associated with Party A may indicate that calls to Party B are almost always terminated before completion, suggesting that such calls are intended to be call-me requests rather than calls that Party A intended to complete. Alternatively, a query of data associated with Party A may indicate that Party A has performed various transactions involving Party B, and therefore a menu of several options may be presented to Party A, allowing Party A to communicate with Party B, or request other services, as actually desired by Party A.

In an embodiment, traffic (e.g., NCS traffic) coming from Party A through one or more network elements may be monitored and related data may be collected. With this data, a behavior profile of Party A may be generated. If the Party A behavior indicated that the current SRRP was inappropriate based on this known behavior, a message may be launched to Party A that educates them as to the availability of the new services available, and the service options presented to Party A may be selected based on their determined value to Party A based on Party A's known behavior. The number of “Party A's” evaluated in an embodiment may include all subscribers of a network or any subset thereof, but may not be limited to a single network. One example is an embodiment that may improve the optimization of service options in the messages by keeping statistics on which services Party A chooses to use or not use. In an embodiment, the behavior of both Party A and Party B may be monitored to establish the type of relationship between the parties based on, for example but without limitation, the frequency of communication, the percentage of A to B calls and/or B to A calls, text messages, and any other combination of A-B or B-A events that may be used to improve the value and convenience of services provisioning to subscribers. In an embodiment, a behavior where Party A always makes intentionally dropped calls to Party B, and Party B always returns those calls, may be recognized. In such an embodiment, a service option may be presented to Party A during a NCS event window offering to reverse connection charges, since the known behavior of the parties indicates that it would be more convenient for both.

Alternatively, default actions may be configured for certain types of messages or options may be presented to a user by default based on the messages. For example, for any call-me request detected for example by determining that the message received at block 305 indicates a call request and subsequent call termination, a default action of generating and transmitting a call-me request may be determined. Alternatively, a default menu presenting other options may be presented to a user, and the call-me request may be transmitted in the absence of a response to such a menu within a predetermined period of time. In yet another alternative, a default menu presenting options, including sending a call-me request, may be presented to a user, and no action may be taken in the absence of a response to such a menu, in one embodiment within a predetermined period of time. Any other actions or responses that may be determined are contemplated as within the scope of the present disclosure.

At block 315, a determination may be made as to whether the determined action(s) are to be taken automatically. As noted above, in some embodiments actions may be taken automatically in response to the message and determination of blocks 305 and 310, while in other embodiments, actions may be taken only after further instruction from a user, or upon expiration of a predetermined amount of time. If the determined action(s) is to be taken automatically, at block 330, the action is taken (e.g., sending a call-me message to Party B).

If the determined action(s) are not to be taken automatically, at block 320 a query may be sent to the user device that initiated, or otherwise caused to be generated, the message received at block 305. Such a query may be simply a confirmation of the user's intent (e.g., query whether to send a call-me message to party B), or an instruction causing the presentation of a menu providing one or more options that a user may select. Note that the query may be transmitted to the user device upon receipt of the message received at block 305 or within a predetermined amount of time from the time of receipt of the message.

At block 325, a determination may be made as to whether a response has been made to the query of block 320. In some embodiments, a response must be received at block 325 within a predetermined amount of time. The predetermined amount of time may begin at the time of transmission of the query at block 315, the time of receipt by a mobile device of the query of block 315, or at any other time. If a response is not received within the predetermined amount of time, at block 330, the determined action(s) may be taken. If a response is received within the predetermined amount of time, at block 335, the action(s) indicated by the response may be taken. Note that in other embodiments, there may be no time limit for response. In yet other embodiments, if no response is received, whether a time limit for response is set or not, no action may be taken. All such embodiments are contemplated as within the scope of the present disclosure.

Upon taking the determined or indicated action(s), at block 340 a notification may be sent to the initiating user (Party A) indicating that the determined or indicated action(s) have been taken. In other embodiments, no follow-up indication may be sent to the initiating user.

Method 300, and the other embodiments set forth herein, may provide a more convenient and more efficient trigger for one or more services, such as, but not limited to, USSD services. As opposed to current USSD-based service provisions that require a subscriber to enter a SNCS, method 300 may allow a subscriber to select a service by input of some type via the mobile device, or by not responding to a query for input, and one or more network elements may trigger the services through alternate means. The present embodiments may also allow a subscriber to use many of the convenience features built into or available on most mobile handsets such as, but not limited to, phone contact number directories that are not currently useable with USSD services. For example, a subscriber may trigger a USSD-based call-me service, where the SNCS *123#4564567890# would be presented to the USSD center for processing the service by one or more network elements.

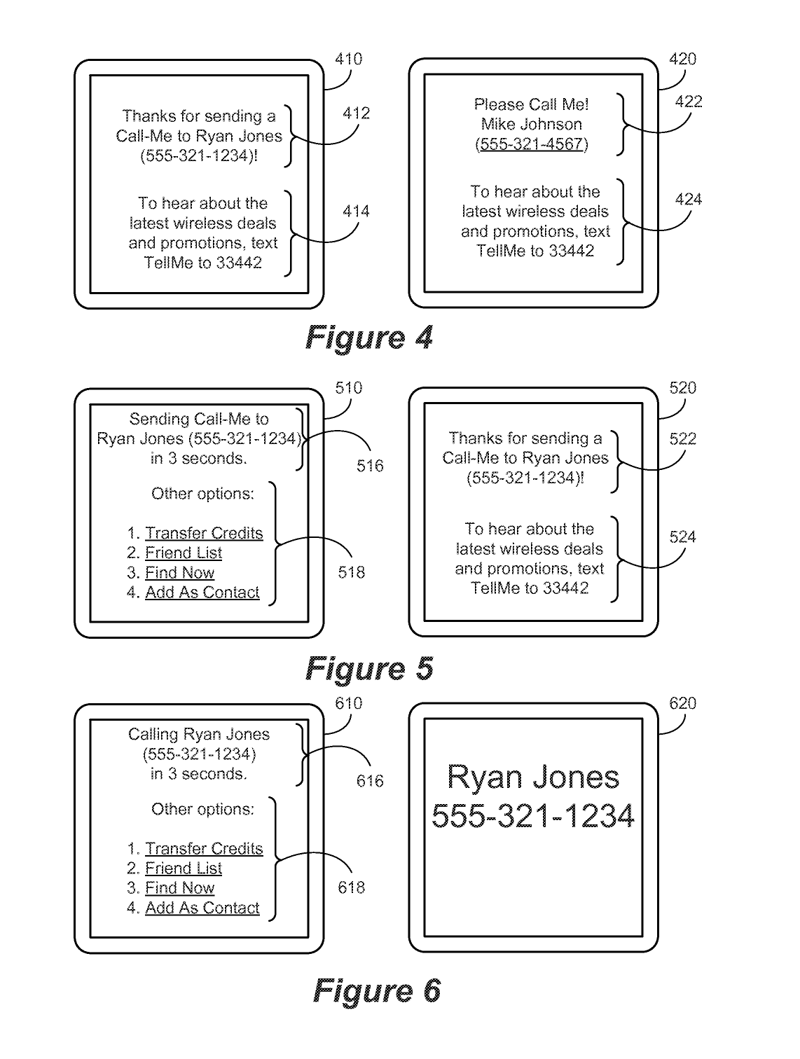

FIG. 4 illustrates example user interfaces that may be presented to one or both of Party A and Party B. Note that the user interfaces shown in FIG. 4 and elsewhere in the present disclosure may be generated by and presented on a mobile device of any type in response to instructions from one or more devices on a wireless network as described herein. Any wording, colors, graphics, sounds, video, images, or any other content may be used in such interfaces, and all such embodiments are contemplated as within the scope of the present disclosure.

Interface 410 may be an interface shown to an initiating user (Party A) upon receipt of a message indicating that it has been determined that Party A has made an intentionally dropped call. In response to such a message, in an embodiment a call-me request may be sent to the determined destination (Party B), which may be presented as user interface 420. User interface 410 may include confirmation 412 that a call-me request has been sent to Party B, and may also include any other information, such as promotional message 414. The call-me request may be presented as request 422 in user interface 420, that may include a control that, when activated, automatically initiates a call to Party A. User interface 420 may also include any other information, such as promotional message 424.

FIG. 5 illustrates example user interfaces that may be presented to Party A. User interface 510 may be an interface shown to an initiating user (Party A) upon receipt of a message indicating that it has been determined that Party A has made an intentionally dropped call. In response to such a message, in an embodiment a call-me request may be automatically sent to the determined destination (Party B) if Party A does not provide contrary instructions within a predetermined timeframe. Message 516 may be presented to Party A indicating the action to be taken and the timeframe, which may be represented as an active countdown timer so that Party A is aware of how much time is left in the predetermined timeframe at the current time. The other actions that Party A may request may be presented as controls in a menu or otherwise presented in user interface 510 as options 518. If no action is taken by Party A within the timeframe the call-me request may be automatically generated and transmitted (recipient interface not shown in FIG. 5, see, e.g., user interface 420 of FIG. 4). Upon transmission of the call-me request, user interface 520 may include confirmation 522 that a call-me request has been sent to Party B, and may also include any other information, such as promotional message 524. Note that in other embodiments where a predetermined timeframe for alternate actions is not used, user interface 510 may not include a countdown time, but rather may simply ask for confirmation of the desire to transmit a call-me request, or may present, as one option among several, a confirmation of a call-me request. In such embodiments, no action may be taken by default if no options are selected or is no confirmation is received from Party A.

FIG. 6 illustrates other example user interfaces that may be presented to Party A. User interface 610 may be an interface shown to an initiating user (Party A) upon receipt of a message indicating that it has been determined that Party A has placed a call (but not terminated the call). In response to such a message, in an embodiment a call as requested may be automatically be placed to the determined destination (Party B) if Party A does not provide contrary instructions within a predetermined timeframe. Message 616 may be presented to Party A indicating the action to be taken and the timeframe, which may be represented as an active countdown timer so that Party A is aware of how much time is left in the predetermined timeframe at the current time. The other actions that Party A may request may be presented as controls in a menu or otherwise presented in user interface 610 as options 618. If no action is taken by Party A within the timeframe a call may be established with Party B and a typical indicator of an active voice call may be provided in user interface 620. Note that in other embodiments where a predetermined timeframe for alternate actions is not used, user interface 610 may not include a countdown time, but rather may simply ask for confirmation of the desire to initiate a voice call to Party B, or may present, as one option among several, a confirmation of call request. In such embodiments, no action may be taken by default if no options are selected or is no confirmation is received from Party A.

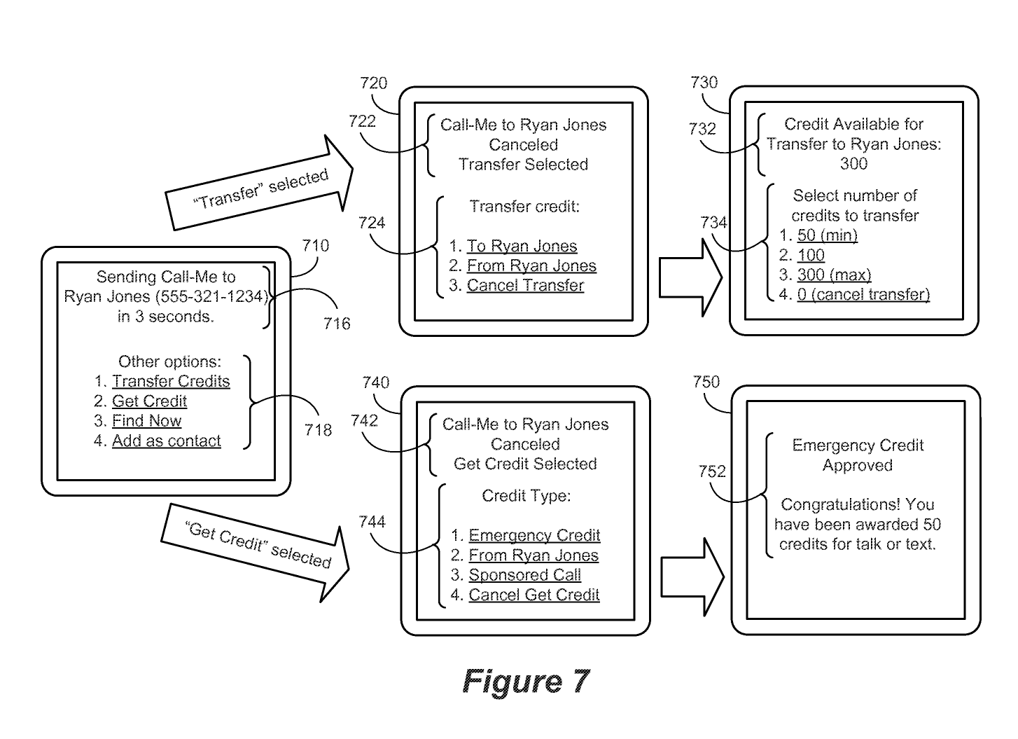

FIG. 7 illustrates yet other example user interfaces that may be presented to Party A. User interface 710 may be an interface shown to an initiating user (Party A) upon receipt of a message indicating that it has been determined that Party A has made an intentionally dropped call. In response to such a message, in an embodiment a call-me request may be automatically sent to the determined destination (Party B) if Party A does not provide contrary instructions within a predetermined timeframe. Message 716 may be presented to Party A indicating the action to be taken and the timeframe, which may be represented as an active countdown timer so that Party A is aware of how much time is left in the predetermined timeframe at the current time. The other actions that Party A may request may be presented as controls in a menu or otherwise presented in user interface 710 as options 718. If no action is taken by Party A within the timeframe the call-me request may be automatically generated and transmitted (recipient interface not shown in FIG. 7, see, e.g., user interface 420 of FIG. 4).

Upon selection of one of options 618, in one example the “Transfer Credits” option, the user may be presented with user interface 720 that may provide indication 722 that a call-me request has been canceled and that credit transfer has been selected. Options 724 may allow the user to further refine the request to transfer. In an example, it may be determined that the credit is to be transferred between the two parties indicated in the original event that initiated the call-me request and options shown in user interface 710 (e.g., an intentionally dropped call between Party A and Party B). Options 724 may inquire as to whether Party A would like to transfer credit to Party B, or transfer credit from Party B to Party A. Any other options relating to transfer of credits may be presented in options 724, including an option to cancel the transfer request.

Upon selection of an option from options 724, user interface 730 may be presented to the user, listing the available credits for transfer (632) and options 734 that may allow the user to select a number of credits. Any other options relating to transfer of credits may be presented in options 734, including an option to cancel the transfer request.

In another example, upon selection of one of options 718, here the “Get Credit” option, the user may be presented with user interface 740 that may provide indication 742 that a call-me request has been canceled and that get credit has been selected. Options 744 may allow the user to further refine the request for credit. In an example, it may be determined that Party A may desire that the credit requested be transferred Party B. Options 744 may inquire as to whether Party A would like to transfer credit from Party B, get emergency credit, make use of a sponsored call, or any other option for obtaining credit. Any other options relating to obtaining credit may be presented in options 744, including an option to cancel the request for credit.

Upon selection of an option from options 744, user interface 750 may be presented to the user, showing the results of the credit award (752) and/or any other messages or options that may relate to the denial, approval, and/or request for more credit, including an option to cancel the transfer request.

The systems and methods described above assist in providing a more appropriate response to user actions and user-caused events. By implementing the present disclosure, network resources and user time may be saved, and therefore networks may operate more efficiently and users may have greater satisfaction with the service received. Set forth below are further exemplary systems, devices, and components in which aspects of the disclosed systems and methods may be implemented.

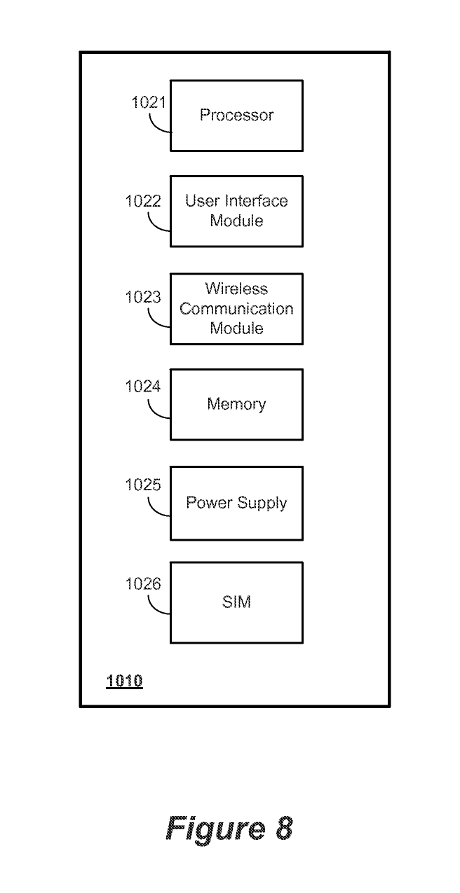

FIG. 8 illustrates an example wireless device 1010 that may be used in connection with an embodiment. References will also be made to other figures of the present disclosure as appropriate. For example, mobile devices 230 and 240 may be wireless devices of the type described in regard to FIG. 8, and may have some, all, or none of the components and modules described in regard to FIG. 8. It will be appreciated that the components and modules of wireless device 1010 illustrated in FIG. 8 are illustrative, and that any number and type of components and/or modules may be present in wireless device 1010. In addition, the functions performed by any or all of the components and modules illustrated in FIG. 8 may be performed by any number of physical components. Thus, it is possible that in some embodiments the functionality of more than one component and/or module illustrated in FIG. 8 may be performed by any number or types of hardware and/or software.

Processor 1021 may be any type of circuitry that performs operations on behalf of wireless device 1010. In one embodiment, processor 1021 executes software (i.e., computer-readable instructions stored on a tangible computer-readable medium) that may include functionality related to the disclosed systems and methods, for example. User interface module 1022 may be any type or combination of hardware and/or software that enables a user to operate and interact with wireless device 1010, and, in one embodiment, to interact with a system or software enabling the user to place, request, and/or receive calls, text communications of any type, emergency alert messages, voicemail, voicemail notifications, voicemail content and/or data, charging and/or billing data, and/or a system or software enabling the user to view, modify, or delete related software objects. For example, user interface module 1022 may include a display, physical and/or “soft” keys, voice recognition software, a microphone, a speaker and the like. Wireless communication module 1023 may be any type of transceiver including any combination of hardware and/or software that enables wireless device 1010 to communicate with wireless network equipment. Memory 1024 enables wireless device 1010 to store information, such as APNs, MNCs, MCCs, text communications content and associated data, multimedia content, software to efficiently process radio resource requests and service requests, and radio resource request processing preferences and configurations. Memory 1024 may take any form, such as internal random access memory (RAM), an SD card, a microSD card and the like. Power supply 1025 may be a battery or other type of power input (e.g., a charging cable that is connected to an electrical outlet, etc.) that is capable of powering wireless device 1010. SIM 1026 may be any type Subscriber Identity Module and may be configured on a removable or non-removable SIM card that allows wireless device 1010 to store data on SIM 1026.

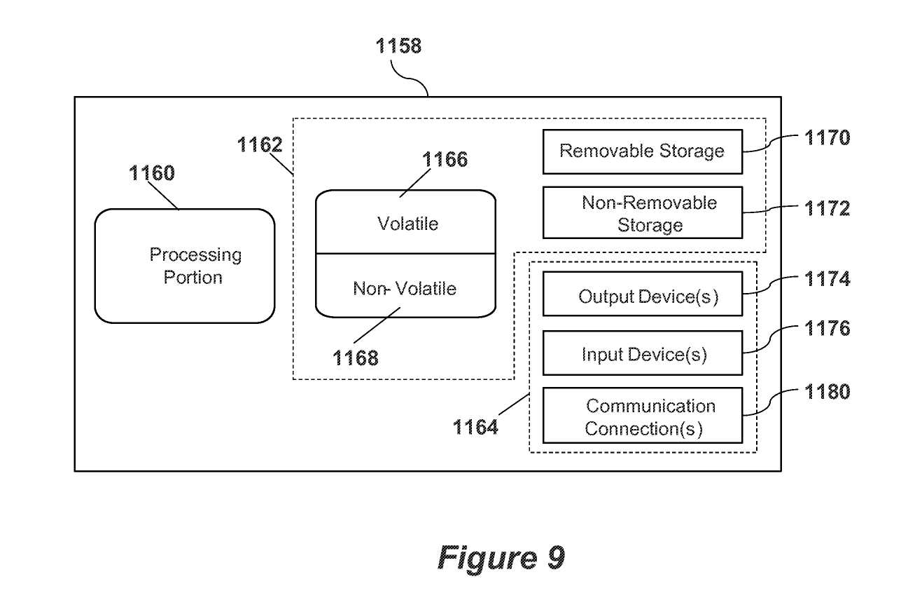

FIG. 9 is a block diagram of an example processor 1158 that may be employed in any of the embodiments described herein, including as one or more components of mobile devices 230 and 240, as one or more components of messaging gateway 220, and/or any related equipment, and/or as one or more components of any third party system or subsystem that may implement any portion of the subject matter described herein. It is emphasized that the block diagram depicted in FIG. 9 is exemplary and not intended to imply a specific implementation. Thus, the processor 1158 can be implemented in a single processor or multiple processors. Multiple processors can be distributed or centrally located. Multiple processors can communicate wirelessly, via hard wire, or a combination thereof.

As depicted in FIG. 9, the processor 1158 comprises a processing portion 1160, a memory portion 1162, and an input/output portion 1164. The processing portion 1160, memory portion 1162, and input/output portion 1164 are coupled together (coupling not shown in FIG. 9) to allow communications between these portions. The input/output portion 1164 is capable of providing and/or receiving components, commands, and/or instructions, utilized to, for example, transmit and/or receive configuration data, transmit and receive device condition data, transmit and receive emergency alert messages and related data, messages, and requests for data, establish and terminate communications sessions, transmit and receive service requests and data access request data and responses, transmit, receive, store and process text, data, and voice communications, execute software that efficiently processes radio resource requests, receive and store service requests and radio resource requests, radio resource request processing preferences and configurations, and/or perform any function described herein.

The processor 1158 may be implemented as a client processor and/or a server processor. In a basic configuration, the processor 1158 may include at least one processing portion 1160 and memory portion 1162. The memory portion 1162 can store any information utilized in conjunction with establishing, transmitting, receiving, and/or processing text, data, and/or voice communications, communications-related data and/or content, voice calls, other telephonic communications, etc. For example, the memory portion is capable of storing condition and event data, emergency alert messages and related data, configuration commands, profiles, thresholds, APNs, MNCs, MCCs, service requests, radio resource requests, QoS and/or APN parameters, device and link status, condition, and congestion data, text and data communications, calls, voicemail, multimedia content, visual voicemail applications, etc. Depending upon the exact configuration and type of processor, the memory portion 1162 may be volatile (such as RAM) 1166, non-volatile (such as ROM, flash memory, etc.) 1168, or a combination thereof. The processor 1158 may have additional features/functionality. For example, the processor 1158 may include additional storage (removable storage 1170 and/or non-removable storage 1172) including, but not limited to, tangible computer-readable storage media such as magnetic disks, optical disks, tapes, flash memory, smart cards, and/or any combination thereof. Computer-readable storage media, such as memory and storage elements 1162, 1170, 1172, 1166, and 1168, may be tangible storage media that may be volatile or nonvolatile, removable or non-removable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other tangible medium that may be used to store the desired information and that can be accessed by the processor 1158. Any such computer storage media may be part of the processor 1158.

The processor 1158 may also contain the communications connection(s) 1180 that allow the processor 1158 to communicate with other devices, for example through a radio access network (RAN). Communications connection(s) 1180 is an example of communication media. Communication media typically embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection as might be used with a land line telephone, and wireless media such as acoustic, RF, infrared, cellular, and other wireless media. The term computer-readable media as used herein may include both storage media and communication media. The processor 1158 also may have input device(s) 1176 such as keyboard, keypad, mouse, pen, voice input device, touch input device, etc. Output device(s) 1174 such as a display, speakers, printer, etc. may also be included.

A RAN as described herein may comprise any telephony radio network, or any other type of communications network, wireline or wireless, or any combination thereof. The following description sets forth some exemplary telephony radio networks, such as the global system for mobile communications (GSM), and non-limiting operating environments. The below-described operating environments should be considered non-exhaustive, however; and thus the below-described network architectures merely show how the disclosed systems and methods may be implemented with stationary and non-stationary network structures and architectures. It will be appreciated, however, that the disclosed systems and methods as described herein may be incorporated with existing and/or future alternative architectures for communication networks as well.

The GSM is one of the most widely utilized wireless access systems in today's fast growing communication environment. The GSM provides circuit-switched data services to subscribers, such as mobile telephone or computer users. The General Packet Radio Service (GPRS), which is an extension to GSM technology, introduces packet switching to GSM networks. The GPRS uses a packet-based wireless communication technology to transfer high and low speed data and signaling in an efficient manner. The GPRS attempts to optimize the use of network and radio resources, thus enabling the cost effective and efficient use of GSM network resources for packet mode applications.

The exemplary GSM/GPRS environment and services described herein also may be extended to 3G services, such as Universal Mobile Telephone System (UMTS), Frequency Division Duplexing (FDD) and Time Division Duplexing (TDD), High Speed Packet Data Access (HSPDA), cdma2000 1x Evolution Data Optimized (EVDO), Code Division Multiple Access-2000 (cdma2000 3x), Time Division Synchronous Code Division Multiple Access (TD-SCDMA), Wideband Code Division Multiple Access (WCDMA), Enhanced Data GSM Environment (EDGE), International Mobile Telecommunications-2000 (IMT-2000), Digital Enhanced Cordless Telecommunications (DECT), 4G Services such as Long Term Evolution (LTE), LTE-Advanced. etc., as well as to other network services that become available in time. In this regard, the disclosed systems and methods may be implemented independently of the method of data transport and does not depend on any particular network architecture or underlying protocols.

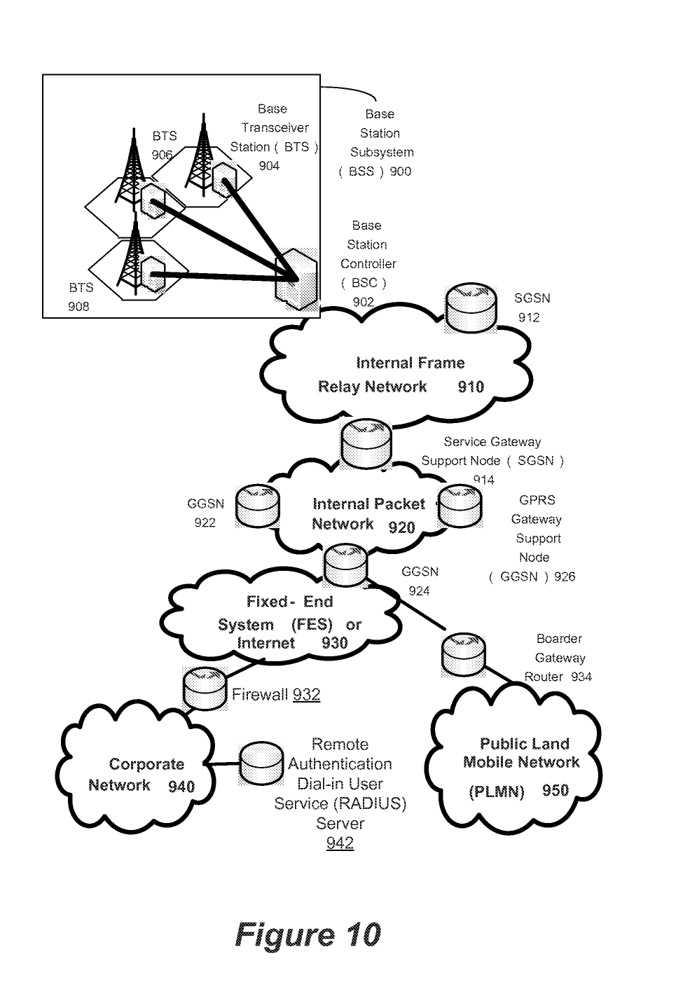

FIG. 10 depicts an overall block diagram of an exemplary packet-based mobile cellular network environment, such as a GPRS network, in which the disclosed systems and methods such as those described herein may be practiced. In an example configuration, any RAN component as described herein may be encompassed by or interact with the network environment depicted in FIG. 10. Similarly, mobile devices 230 and 240 may communicate or interact with a network environment such as that depicted in FIG. 10. In such an environment, there may be a plurality of Base Station Subsystems (BSS) 900 (only one is shown), each of which comprises a Base Station Controller (BSC) 902 serving a plurality of Base Transceiver Stations (BTS) such as BTSs 904, 906, and 908. BTSs 904, 906, 908, etc. are the access points where users of packet-based mobile devices (e.g., mobile devices 230 and 240) become connected to the wireless network. In exemplary fashion, the packet traffic originating from user devices (e.g., mobile devices 230 and 240) may be transported via an over-the-air interface to a BTS 908, and from the BTS 908 to the BSC 902. Base station subsystems, such as BSS 900, may be a part of internal frame relay network 910 that can include Service GPRS Support Nodes (SGSN) such as SGSN 912 and 914. Each SGSN may be connected to an internal packet network 920 through which a SGSN 912, 914, etc., may route data packets to and from a plurality of gateway GPRS support nodes (GGSN) 922, 924, 926, etc. As illustrated, SGSN 914 and GGSNs 922, 924, and 926 may be part of internal packet network 920. Gateway GPRS serving nodes 922, 924 and 926 may provide an interface to external Internet Protocol (IP) networks, such as Public Land Mobile Network (PLMN) 950, corporate intranets 940, or Fixed-End System (FES) or the public Internet 930. As illustrated, subscriber corporate network 940 may be connected to GGSN 924 via firewall 932, and PLMN 950 may be connected to GGSN 924 via border gateway router 934. The Remote Authentication Dial-In User Service (RADIUS) server 942 may be used for caller authentication when a user of a mobile cellular device calls corporate network 940.

Generally, there may be four different cell sizes in a GSM network, referred to as macro, micro, pico, and umbrella cells. The coverage area of each cell is different in different environments. Macro cells may be regarded as cells in which the base station antenna is installed in a mast or a building above average roof top level. Micro cells are cells whose antenna height is under average roof top level. Micro-cells may be typically used in urban areas. Pico cells are small cells having a diameter of a few dozen meters. Pico cells may be used mainly indoors. On the other hand, umbrella cells may be used to cover shadowed regions of smaller cells and fill in gaps in coverage between those cells.

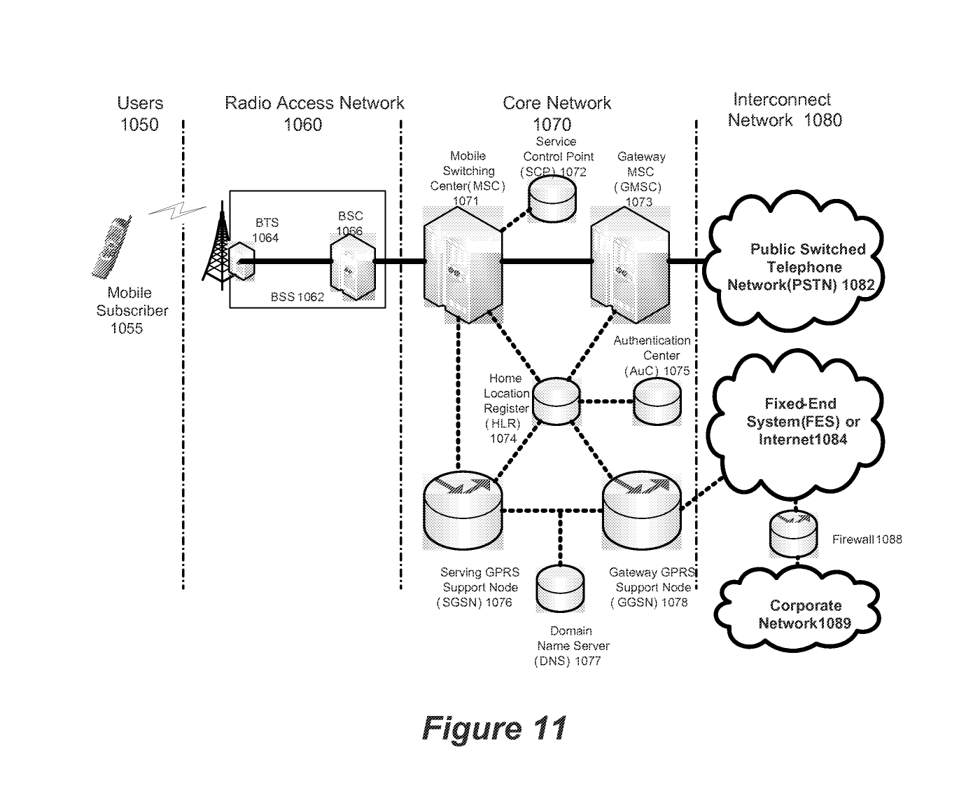

FIG. 11 illustrates an architecture of a typical GPRS network segmented into four groups: users 1050, radio access network 1060, core network 1070, and interconnect network 1080. Users 1050 may comprise a plurality of end users (although only mobile subscriber 1055 is shown in FIG. 11). In an example embodiment, the device depicted as mobile subscriber 1055 may comprise any of mobile devices 230 and 240. Radio access network 1060 comprises a plurality of base station subsystems such as BSSs 1062, which may include BTSs 1064 and BSCs 1066. Core network 1070 comprises a host of various network elements. As illustrated here, core network 1070 may comprise Mobile Switching Center (MSC) 1071, Service Control Point (SCP) 1072, gateway MSC 1073, SGSN 1076, Home Location Register (HLR) 1074, Authentication Center (AuC) 1075, Domain Name Server (DNS) 1077, and GGSN 1078. Interconnect network 1080 may also comprise a host of various networks and other network elements. As illustrated in FIG. 11, interconnect network 1080 comprises Public Switched Telephone Network (PSTN) 1082, Fixed-End System (FES) or Internet 1084, firewall 1088, and Corporate Network 1089.

A mobile switching center may be connected to a large number of base station controllers. At MSC 1071, for instance, depending on the type of traffic, the traffic may be separated in that voice may be sent to Public Switched Telephone Network (PSTN) 1082 through Gateway MSC (GMSC) 1073, and/or data may be sent to SGSN 1076 that may send the data traffic to GGSN 1078 for further forwarding.

When MSC 1071 receives call traffic, for example, from BSC 1066, it may send a query to a database hosted by SCP 1072. The SCP 1072 may process the request and may issue a response to MSC 1071 so that it may continue call processing as appropriate.

The HLR 1074 may be a centralized database for users to register to the GPRS network. HLR 1074 may store static information about the subscribers such as the International Mobile Subscriber Identity (IMSI), APN profiles, subscribed services, and a key for authenticating the subscriber. HLR 1074 may also store dynamic subscriber information such as dynamic APN profiles and the current location of the mobile subscriber. HLR 1074 may also serve to intercept and determine the validity of destination numbers in messages sent from a device, such as mobile subscriber 1055, as described herein. Associated with HLR 1074 may be AuC 1075. AuC 1075 may be a database that contains the algorithms for authenticating subscribers and may include the associated keys for encryption to safeguard the user input for authentication.

In the following, depending on context, the term “mobile subscriber” sometimes refers to the end user and sometimes to the actual portable device, such as mobile devices 230 and 240, used by an end user of a mobile cellular service or a wireless provider. When a mobile subscriber turns on his or her mobile device, the mobile device may go through an attach process by which the mobile device attaches to an SGSN of the GPRS network. In FIG. 11, when mobile subscriber 1055 initiates the attach process by turning on the network capabilities of the mobile device, an attach request may be sent by mobile subscriber 1055 to SGSN 1076. The SGSN 1076 queries another SGSN, to which mobile subscriber 1055 was attached before, for the identity of mobile subscriber 1055. Upon receiving the identity of mobile subscriber 1055 from the other SGSN, SGSN 1076 may request more information from mobile subscriber 1055. This information may be used to authenticate mobile subscriber 1055 to SGSN 1076 by HLR 1074. Once verified, SGSN 1076 sends a location update to HLR 1074 indicating the change of location to a new SGSN, in this case SGSN 1076. HLR 1074 may notify the old SGSN, to which mobile subscriber 1055 was attached before, to cancel the location process for mobile subscriber 1055. HLR 1074 may then notify SGSN 1076 that the location update has been performed. At this time, SGSN 1076 sends an Attach Accept message to mobile subscriber 1055, which in turn sends an Attach Complete message to SGSN 1076.

After attaching itself to the network, mobile subscriber 1055 may then go through the authentication process. In the authentication process, SGSN 1076 may send the authentication information to HLR 1074, which may send information back to SGSN 1076 based on the user profile that was part of the user's initial setup. The SGSN 1076 may then send a request for authentication and ciphering to mobile subscriber 1055. The mobile subscriber 1055 may use an algorithm to send the user identification (ID) and password to SGSN 1076. The SGSN 1076 may use the same algorithm and compares the result. If a match occurs, SGSN 1076 authenticates mobile subscriber 1055.

Next, the mobile subscriber 1055 may establish a user session with the destination network, corporate network 1089, by going through a Packet Data Protocol (PDP) activation process. Briefly, in the process, mobile subscriber 1055 may request access to an Access Point Name (APN), for example, UPS.com, and SGSN 1076 may receive the activation request from mobile subscriber 1055. SGSN 1076 may then initiate a Domain Name Service (DNS) query to learn which GGSN node has access to the UPS.com APN. The DNS query may be sent to the DNS server within the core network 1070, such as DNS 1077, that may be provisioned to map to one or more GGSN nodes in the core network 1070. Based on the APN, the mapped GGSN 1078 may access the requested corporate network 1089. The SGSN 1076 may then send to GGSN 1078 a Create Packet Data Protocol (PDP) Context Request message that contains necessary information. The GGSN 1078 may send a Create PDP Context Response message to SGSN 1076, which may then send an Activate PDP Context Accept message to mobile subscriber 1055.

Once activated, data packets of the call made by mobile subscriber 1055 may then go through radio access network 1060, core network 1070, and interconnect network 1080, in a particular fixed-end system, or Internet 1084 and firewall 1088, to reach corporate network 1089.

Thus, network elements that can invoke the functionality of the disclosed systems and methods described herein may include, but are not limited to, any RAN component, Gateway GPRS Support Node tables, Fixed End System router tables, firewall systems, VPN tunnels, and any number of other network elements as required by the particular digital network.

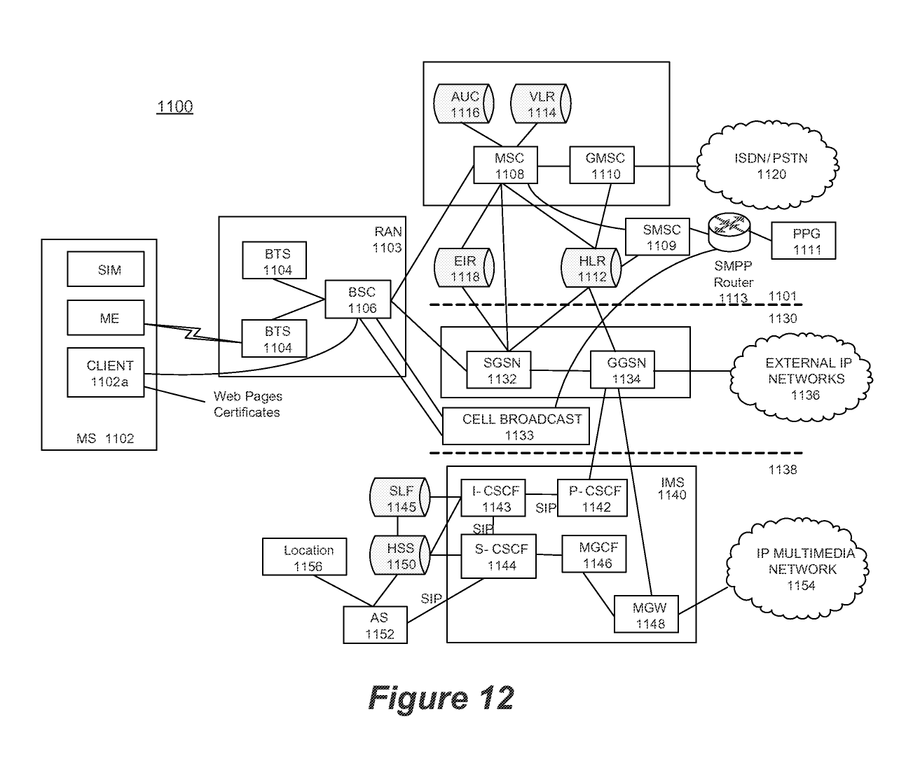

FIG. 12 illustrates another exemplary block diagram view of a GSM/GPRS/IP multimedia network architecture 1100 in which the disclosed embodiments may be incorporated. As illustrated, architecture 1100 of FIG. 12 includes a GSM core network 1101, a GPRS network 1130 and an IP multimedia network 1138. The GSM core network 1101 includes a Mobile Station (MS) 1102, at least one Base Transceiver Station (BTS) 1104 and a Base Station Controller (BSC) 1106. The MS 1102 may be physical equipment or Mobile Equipment (ME), such as a mobile telephone or a laptop computer (e.g., mobile devices 230 and 240) that may be used by mobile subscribers, in one embodiment with a Subscriber identity Module (SIM). The SIM may include an International Mobile Subscriber Identity (IMSI), which may be a unique identifier of a subscriber. The SIM may also include APNs. The BTS 1104 may be physical equipment, such as a radio tower, that enables a radio interface to communicate with the MS. Each BTS may serve more than one MS. The BSC 1106 may manage radio resources, including the BTS. The BSC may be connected to several BTSs. The BSC and BTS components, in combination, are generally referred to as a base station (BSS) or radio access network (RAN) 1103.

The GSM core network 1101 may also include a Mobile Switching Center (MSC) 1108, a Gateway Mobile Switching Center (GMSC) 1110, a Home Location Register (HLR) 1112, Visitor Location Register (VLR) 1114, an Authentication Center (AuC) 1118, and an Equipment Identity Register (EIR) 1116. The MSC 1108 may perform a switching function for the network. The MSC may also perform other functions, such as registration, authentication, location updating, handovers, and call routing. The GMSC 1110 may provide a gateway between the GSM network and other networks, such as an Integrated Services Digital Network (ISDN) or Public Switched Telephone Networks (PSTNs) 1120. Thus, the GMSC 1110 provides interworking functionality with external networks.

The HLR 1112 may be a database that may contain administrative information regarding each subscriber registered in a corresponding GSM network. Such information may include APNs and APN profiles. The HLR 1112 may also contain the current location of each MS. The VLR 1114 may be a database that contains selected administrative information from the HLR 1112. The VLR may contain information necessary for call control and provision of subscribed services for each MS currently located in a geographical area controlled by the VLR. The HLR 1112 and the VLR 1114, together with the MSC 1108, may provide the call routing and roaming capabilities of GSM. The AuC 1116 may provide the parameters needed for authentication and encryption functions. Such parameters allow verification of a subscriber's identity. The EIR 1118 may store security-sensitive information about the mobile equipment.

A Short Message Service Center (SMSC) 1109 allows one-to-one short message service (SMS), or multimedia message service (MMS), messages to be sent to/from the MS 1102. A Push Proxy Gateway (PPG) 1111 is used to “push” (i.e., send without a synchronous request) content to the MS 1102. The PPG 1111 acts as a proxy between wired and wireless networks to facilitate pushing of data to the MS 1102. A Short Message Peer to Peer (SMPP) protocol router 1113 may be provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as voice, data, short message service (SMS), and multimedia message service (MMS), the MS may first register with the network to indicate its current location by performing a location update and IMSI attach procedure. MS 1102 may send a location update including its current location information to the MSC/VLR, via BTS 1104 and BSC 1106. The location information may then be sent to the MS's HLR. The HLR may be updated with the location information received from the MSC/VLR. The location update may also be performed when the MS moves to a new location area. Typically, the location update may be periodically performed to update the database as location updating events occur.

GPRS network 1130 may be logically implemented on the GSM core network architecture by introducing two packet-switching network nodes, a serving GPRS support node (SGSN) 1132, a cell broadcast and a Gateway GPRS support node (GGSN) 1134. The SGSN 1132 may be at the same hierarchical level as the MSC 1108 in the GSM network. The SGSN may control the connection between the GPRS network and the MS 1102. The SGSN may also keep track of individual MS's locations and security functions and access controls.

Cell Broadcast Center (CBC) 1133 may communicate cell broadcast messages that are typically delivered to multiple users in a specified area. Cell Broadcast is one-to-many geographically focused service. It enables messages to be communicated to multiple mobile telephone customers who are located within a given part of its network coverage area at the time the message is broadcast.

GGSN 1134 may provide a gateway between the GPRS network and a public packet network (PDN) or other IP networks 1136. That is, the GGSN may provide interworking functionality with external networks, and set up a logical link to the MS through the SGSN. When packet-switched data leaves the GPRS network, it may be transferred to an external TCP-IP network 1136, such as an X.25 network or the Internet. In order to access GPRS services, the MS first attaches itself to the GPRS network by performing an attach procedure. The MS may then activate a packet data protocol (PDP) context, thus activating a packet communication session between the MS, the SGSN, and the GGSN.

In a GSM/GPRS network, GPRS services and GSM services may be used in parallel. The MS may operate in one three classes: class A, class B, and class C. A class A MS may attach to the network for both GPRS services and GSM services simultaneously. A class A MS may also support simultaneous operation of GPRS services and GSM services. For example, class A mobiles may receive GSM voice/data/SMS calls and GPRS data calls at the same time.

A class B MS may attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

GPRS network 1130 may be designed to operate in three network operation modes (NOM1, NOM2 and NOM3). A network operation mode of a GPRS network may be indicated by a parameter in system information messages transmitted within a cell. The system information messages may direct an MS where to listen for paging messages and how to signal towards the network. The network operation mode represents the capabilities of the GPRS network. In a NOM1 network, a MS may receive pages from a circuit switched domain (voice call) when engaged in a data call. The MS may suspend the data call or take both simultaneously, depending on the ability of the MS. In a NOM2 network, a MS may not receive pages from a circuit switched domain when engaged in a data call, since the MS may be receiving data and may not be listening to a paging channel. In a NOM3 network, a MS may monitor pages for a circuit switched network while receiving data and vice versa.

The IP multimedia network 1138 was introduced with 3GPP Release 5, and may include IP multimedia subsystem (IMS) 1140 to provide rich multimedia services to end users. A representative set of the network entities within IMS 1140 are a call/session control function (CSCF), a media gateway control function (MGCF) 1146, a media gateway (MGW) 1148, and a master subscriber database, called a home subscriber server (HSS) 1150. HSS 1150 may be common to GSM core network 1101, GPRS network 1130 as well as IP multimedia network 1138.

IP multimedia system 1140 may be built around the call/session control function, of which there are three types: an interrogating CSCF (I-CSCF) 1143, a proxy CSCF (P-CSCF) 1142, and a serving CSCF (S-CSCF) 1144. The P-CSCF 1142 is the MS's first point of contact with the IMS 1140. The P-CSCF 1142 may forward session initiation protocol (SIP) messages received from the MS to an SIP server in a home network (and vice versa) of the MS. The P-CSCF 1142 may also modify an outgoing request according to a set of rules defined by the network operator (for example, address analysis and potential modification).

I-CSCF 1143 forms an entrance to a home network and hides the inner topology of the home network from other networks and provides flexibility for selecting an S-CSCF. I-CSCF 1143 may contact subscriber location function (SLF) 1145 to determine which HSS 1150 to use for the particular subscriber, if multiple HSSs 1150 are present. S-CSCF 1144 may perform the session control services for MS 1102. This includes routing originating sessions to external networks and routing terminating sessions to visited networks. S-CSCF 1144 may also decide whether an application server (AS) 1152 is required to receive information on an incoming SIP session request to ensure appropriate service handling. This decision may be based on information received from HSS 1150 (or other sources, such as application server 1152). AS 1152 may also communicate to location server 1156 (e.g., a Gateway Mobile Location Center (GMLC)) that provides a position (e.g., latitude/longitude coordinates) of MS 1102.

HSS 1150 may contain a subscriber profile and keep track of which core network node is currently handling the subscriber. It may also support subscriber authentication and authorization functions (AAA). In networks with more than one HSS 1150, a subscriber location function provides information on the HSS 1150 that contains the profile of a given subscriber.

MGCF 1146 may provide interworking functionality between SIP session control signaling from the IMS 1140 and ISUP/BICC call control signaling from the external GSTN networks (not shown.) It may also control the media gateway (MGW) 1148 that provides user-plane interworking functionality (e.g., converting between AMR- and PCM-coded voice.) MGW 1148 may also communicate with other IP multimedia networks 1154.

Push to Talk over Cellular (PoC) capable mobile telephones may register with the wireless network when the telephones are in a predefined area (e.g., job site, etc.) When the mobile telephones leave the area, they may register with the network in their new location as being outside the predefined area. This registration, however, does not indicate the actual physical location of the mobile telephones outside the pre-defined area.

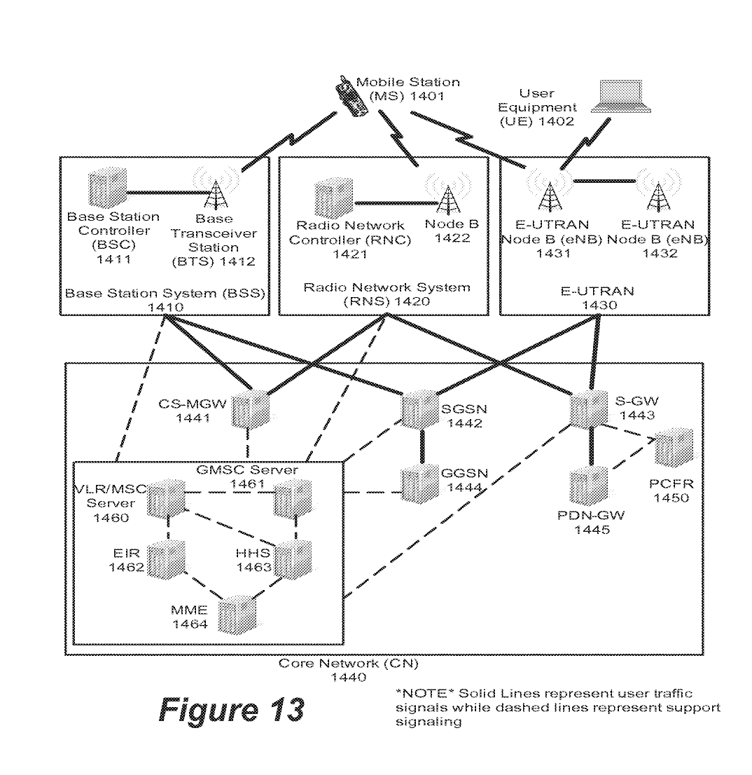

FIG. 13 illustrates a PLMN block diagram view of an example architecture in which the disclosed systems and methods may be incorporated. Mobile Station (MS) 1401 is the physical equipment used by the PLMN subscriber. In one illustrative embodiment, any of mobile devices 230 and 240 may serve as Mobile Station 1401. Mobile Station 1401 may be one of, but not limited to, a cellular telephone, a cellular telephone in combination with another electronic device, or any other wireless mobile communication device.

Mobile Station 1401 may communicate wirelessly with Base Station System (BSS) 1410. BSS 1410 contains a Base Station Controller (BSC) 1411 and a Base Transceiver Station (BTS) 1412. BSS 1410 may include a single BSC 1411/BTS 1412 pair (Base Station) or a system of BSC/BTS pairs which are part of a larger network. BSS 1410 is responsible for communicating with Mobile Station 1401 and may support one or more cells. BSS 1410 is responsible for handling cellular traffic and signaling between Mobile Station 1401 and Core Network 1440. Typically, BSS 1410 performs functions that include, but are not limited to, digital conversion of speech channels, allocation of channels to mobile devices, paging, and transmission/reception of cellular signals.

Additionally, Mobile Station 1401 may communicate wirelessly with Radio Network System (RNS) 1420. RNS 1420 contains a Radio Network Controller (RNC) 1421 and one or more Node(s) B 1422. RNS 1420 may support one or more cells. RNS 1420 may also include one or more RNC 1421/Node B 1422 pairs or alternatively a single RNC 1421 may manage multiple Nodes B 1422. RNS 1420 may be responsible for communicating with Mobile Station 1401 in its geographically defined area. RNC 1421 may be responsible for controlling the Node(s) B 1422 that are connected to it and is a control element in a UMTS radio access network. RNC 1421 may perform functions such as, but not limited to, load control, packet scheduling, handover control, security functions, as well as controlling Mobile Station 1401's access to the Core Network (CN) 1440.

The evolved UMTS Terrestrial Radio Access Network (E-UTRAN) 1430 is a radio access network that provides wireless data communications for Mobile Station 1401 and User Equipment 1402. E-UTRAN 1430 provides higher data rates than traditional UMTS. It is part of the Long Term Evolution (LTE) upgrade for mobile networks and later releases meet the requirements of the International Mobile Telecommunications (IMT) Advanced and are commonly known as a 4G networks. E-UTRAN 1430 may include of series of logical network components such as E-UTRAN Node B (eNode B, may also be referred to as an “eNB”) 1431 and E-UTRAN Node B (eNB) 1432. E-UTRAN 1430 may contain one or more eNBs. User Equipment 1402 may be any user device capable of connecting to E-UTRAN 1430 including, but not limited to, a personal computer, laptop, mobile device, wireless router, or other device capable of wireless connectivity to E-UTRAN 1430. The improved performance of the E-UTRAN 1430 relative to a typical UMTS network allows for increased bandwidth, spectral efficiency, and functionality including, but not limited to, voice, high-speed applications, large data transfer and IPTV, while still allowing for full mobility.

An example embodiment of a mobile data and communication service that may be implemented in the PLMN architecture described in FIG. 13 is the Enhanced Data rates for GSM Evolution (EDGE). EDGE is an enhancement for GPRS networks that implements an improved signal modulation scheme known as 8-PSK (Phase Shift Keying). By increasing network utilization, EDGE may achieve up to three times faster data rates as compared to a typical GPRS network. EDGE may be implemented on any GSM network capable of hosting a GPRS network, making it an ideal upgrade over GPRS since it may provide increased functionality of existing network resources. Evolved EDGE networks are becoming standardized in later releases of the radio telecommunication standards, which provide for even greater efficiency and peak data rates of up to 1 Mbit/s, while still allowing implementation on existing GPRS-capable network infrastructure.

Typically Mobile Station 1401 may communicate with any or all of BSS 1410, RNS 1420, or E-UTRAN 1430. In an illustrative system, each of BSS 1410, RNS 1420, and E-UTRAN 1430 may provide Mobile Station 1401 with access to Core Network 1440. The Core Network 1440 may include of a series of devices that route data and communications between end users. Core Network 1440 may provide network service functions to users in the Circuit Switched (CS) domain, the Packet Switched (PS) domain or both. The CS domain refers to connections in which dedicated network resources are allocated at the time of connection establishment and then released when the connection is terminated. The PS domain refers to communications and data transfers that make use of autonomous groupings of bits called packets. Each packet may be routed, manipulated, processed or handled independently of all other packets in the PS domain and does not require dedicated network resources.

The Circuit Switched-Media Gateway Function (CS-MGW) 1441 is part of Core Network 1440, and interacts with Visitor Location Register (VLR) and Mobile-Services Switching Center (MSC) Server 1460 and Gateway MSC Server 1461 in order to facilitate Core Network 1440 resource control in the CS domain. Functions of CS-MGW 1441 may include, but are not limited to, media conversion, bearer control, payload processing and other mobile network processing such as handover or anchoring. CS-MGW 1441 may receive connections to Mobile Station 1401 through BSS 1410, RNS 1420 or both.

Serving GPRS Support Node (SGSN) 1442 stores subscriber data regarding Mobile Station 1401 in order to facilitate network functionality. SGSN 1442 may store subscription information such as, but not limited to, the International Mobile Subscriber Identity (IMSI), temporary identities, or Packet Data Protocol (PDP) addresses. SGSN 1442 may also store location information such as, but not limited to, the Gateway GPRS Support Node (GGSN) 1444 address for each GGSN where an active PDP exists. GGSN 1444 may implement a location register function to store subscriber data it receives from SGSN 1442 such as subscription or location information.

Serving Gateway (S-GW) 1443 is an interface which provides connectivity between E-UTRAN 1430 and Core Network 1440. Functions of S-GW 1443 may include, but are not limited to, packet routing, packet forwarding, transport level packet processing, event reporting to Policy and Charging Rules Function (PCRF) 1450, and mobility anchoring for inter-network mobility. PCRF 1450 uses information gathered from S-GW 1443, as well as other sources, to make applicable policy and charging decisions related to data flows, network resources and other network administration functions. Packet Data Network Gateway (PDN-GW) 1445 may provide user-to-services connectivity functionality including, but not limited to, network-wide mobility anchoring, bearer session anchoring and control, and IP address allocation for PS domain connections.

Home Subscriber Server (HSS) 1463 is a database for user information and may store subscription data regarding Mobile Station 1401 or User Equipment 1402 for handling calls or data sessions. Networks may contain one HSS 1463 or more if additional resources are required. Example data stored by HSS 1463 may include, but is not limited to, user identification, numbering and addressing information, security information, or location information. HSS 1463 may also provide call or session establishment procedures in both the PS and CS domains.

The VLR/MSC Server 1460 provides user location functionality. When Mobile Station 1401 enters a new network location, it begins a registration procedure. A MSC Server for that location transfers the location information to the VLR for the area. A VLR and MSC Server may be located in the same computing environment, as is shown by VLR/MSC Server 1460, or alternatively may be located in separate computing environments. A VLR may contain, but is not limited to, user information such as the IMSI, the Temporary Mobile Station Identity (TMSI), the Local Mobile Station Identity (LMSI), the last known location of the mobile station, or the SGSN where the mobile station was previously registered. The MSC server may contain information such as, but not limited to, procedures for Mobile Station 1401 registration or procedures for handover of Mobile Station 1401 to a different section of the Core Network 1440. GMSC Server 1461 may serve as a connection to alternate GMSC Servers for other mobile stations in larger networks.

Equipment Identity Register (EIR) 1462 is a logical element which may store the International Mobile Equipment Identities (IMEI) for Mobile Station 1401. In a typical embodiment, user equipment may be classified as either “white listed” or “black listed” depending on its status in the network. In one embodiment, if Mobile Station 1401 is stolen and put to use by an unauthorized user, it may be registered as “black listed” in EIR 1462, preventing its use on the network. Mobility Management Entity (MME) 1464 is a control node which may track Mobile Station 1401 or User Equipment 1402 if the devices are idle. Additional functionality may include the ability of MME 1464 to contact an idle Mobile Station 1401 or User Equipment 1402 if retransmission of a previous session is required.

While example embodiments of the disclosed systems and methods have been described in connection with various computing devices/processors, the underlying concepts may be applied to any computing device, processor, or system capable of implementing the disclosed systems and methods. The various techniques described herein may be implemented in connection with hardware or software or, where appropriate, with a combination of both. Thus, the disclosed systems and methods may be implemented, or certain aspects or portions thereof, may take the form of program code (i.e., instructions) embodied in tangible storage media having a tangible physical structure. Examples of tangible storage media include floppy diskettes, CD-ROMs, DVDs, hard drives, or any other tangible machine-readable storage medium (computer-readable storage medium). Thus, a computer-readable storage medium is neither a transient nor a propagating signal per se. When the program code is loaded into and executed by a machine, such as a computer, the machine becomes an apparatus for implementing the disclosed systems and methods. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

While the disclosed systems and methods have been described in connection with the various embodiments of the various figures, it is to be understood that other similar embodiments may be used or modifications and additions may be made to the described embodiments for performing the same functions of the disclosed systems and methods without deviating therefrom. For example, one skilled in the art will recognize that the disclosed systems and methods as described in the present application may apply to any environment, whether wired or wireless, and may be applied to any number of such devices connected via a communications network and interacting across the network. Therefore, the disclosed systems and methods should not be limited to any single embodiment, but rather should be construed in breadth and scope in accordance with the appended claims.

What is claimed is:

1. A method comprising:
detecting, at a messaging gateway, a first indication that an access attempt was initiated by a mobile device;
responsive to detecting the first indication, transmitting, from the messaging gateway, an instruction to present a menu of options on the mobile device;
receiving, at the messaging gateway, a second indication that a user has selected at least one option from the menu of options within a predetermined amount of time after the menu has been presented; and
responsive to receiving the second indication, initiating, at the messaging gateway, at least one service associated with the at least one option.

2. The method of claim 1, wherein the first indication comprises an identifier of the mobile device and an identifier of a recipient device.

3. The method of claim 2, wherein the identifier of the mobile device and the identifier of the recipient device are a same identifier.

4. The method of claim 1, wherein the first indication indicates that the access attempt was terminated by a network device.

5. The method of claim 1, wherein the instruction to present the menu of options on the mobile device is transmitted within a second predetermined amount of time after the first indication is detected by the messaging gateway.

6. The method of claim 1, wherein the first indication indicates that the access attempt was terminated by the mobile device within a second predetermined amount of time after the access attempt was initiated by the mobile device.

7. The method of claim 1, wherein the instruction to present the menu of options comprises an instruction to present the second predetermined amount of time.

8. A messaging gateway comprising:
a memory comprising computer instructions; and
a processor coupled to the memory, wherein, when executing the computer instructions, the processor effectuates operations comprising:
detecting a first indication that an access attempt was initiated by a mobile device;
responsive to detecting the first indication, transmitting an instruction to present a menu of options on the mobile device;
receiving a second indication that a user has selected at least one option from the menu of options within a predetermined amount of time after the menu has been presented; and
responsive to receiving the second indication, initiating at least one service associated with the at least one option.

9. The messaging gateway of claim 8, wherein the first indication comprises an identifier of the mobile device and an identifier of a recipient device.

10. The messaging gateway of claim 9, wherein the identifier of the mobile device and the identifier of the recipient device are a same identifier.

11. The messaging gateway of claim 8, wherein the first indication indicates that the access attempt was terminated by a network device.

12. The messaging gateway of claim 8, wherein the instruction to present the menu of options on the mobile device is transmitted within a second predetermined amount of time after the first indication is detected.

13. The messaging gateway of claim 8, wherein the first indication indicates that the access attempt was terminated by the mobile device within a second predetermined amount of time after the access attempt was initiated by the mobile device.

14. The messaging gateway of claim 8, wherein the instruction to present the menu of options comprises an instruction to present the second predetermined amount of time.

15. A computer-readable storage medium that is not a propagating signal, the computer-readable storage medium comprising executable instructions that when executed by a processor cause the processor to effectuate operations comprising:
detecting a first indication that an access attempt was initiated by a mobile device;
responsive to detecting the first indication, transmitting an instruction to present a menu of options on the mobile device;
receiving a second indication that a user has selected at least one option from the menu of options within a predetermined amount of time after the menu has been presented; and
responsive to receiving the second indication, initiating at least one service associated with the at least one option.

16. The computer-readable storage medium of claim 15, wherein the first indication comprises an identifier of the mobile device and an identifier of a recipient device.

17. The computer-readable storage medium of claim 16, wherein the identifier of the mobile device and the identifier of the recipient device are a same identifier.

18. The computer-readable storage medium of claim 15, wherein the first indication indicates that the access attempt was terminated by a network device.

19. The computer-readable storage medium of claim 15, wherein the instruction to present the menu of options on the mobile device is transmitted within a second predetermined amount of time after the first indication is detected.

20. The computer-readable storage medium of claim 15, wherein the first indication indicates that the access attempt was terminated by the mobile device within a second predetermined amount of time after the access attempt was initiated by the mobile device.
